(19) United States
(12) Patent Application Publication
(10) Pub. No.: US 2023/0357494 A1
(43) Pub. Date: Nov. 9, 2023

(54) IMPROVED OXYGEN BARRIER OF 1,4-BUTANEDIOL CONTAINING POLYMERS

(71) Applicant: BASF SE, Ludwigshafen (DE)

(72) Inventors: Erik Gubbels, Ludwigshafen (DE); Maximilian Lehenmeier, Ludwigshafen (DE)

(21) Appl. No.: 18/019,592

(22) PCT Filed: Aug. 6, 2021
(86) PCT No.: PCT/EP2021/071999

§ 371 Date: Feb. 3, 2023

(30) Foreign Application Priority Data
Aug. 7, 2020 (EP) 20189999.4

(51) Int. Cl. C08F 136/06; C08G 63/183; C08G 63/82; C08L 67/02

(52) U.S. Cl. CPC C08G 63/183; C08F 136/06; C08G 63/826; C08L 67/02; C08L 2201/14

(57) ABSTRACT

In a first aspect, the invention relates to a polymer composition comprising (i) a polyester; and (ii) an oxidizable organic polymer consisting of a branched or unbranched alkyl chain, which comprises at least one oxidizable C═C double bond. A second aspect of the invention relates to the use of the polymer composition according to the first aspect for the preparation of a polymer article. In a third aspect, the invention relates to a polymer article comprising the polymer composition according to the first aspect. In a fourth aspect, the invention relates to a method for preparing a polymer composition having oxygen consumption activity.

In a first aspect, the invention relates to a polymer composition comprising (i) a polyester and (ii) an oxidizable organic polymer consisting of a branched or unbranched alkyl chain, which comprises at least one oxidizable C═C double bond. A second aspect of the invention relates to the use of the polymer composition according to the first aspect for the preparation of a polymer article. In a third aspect, the invention relates to a polymer article comprising the polymer composition according to the first aspect. In a fourth aspect, the invention relates to a method for preparing a polymer composition having oxygen consumption activity.

Thermoplastic polymeric compositions are widely used in the packaging industry for making various packaging articles for storing oxygen-sensitive products, such as food or beverages. Storage of oxygen sensitive products requires first good barrier properties of the packaging material in order to avoid entrance of oxygen containing gaseous media, such as air. Second, oxygen scavenging properties are desired, in order to reduce the amount of oxygen enclosed together with the stored oxygen-sensitive product.

EP 1 889 704 A1 describes a dry blend having oxygen-scavenging properties, and the use thereof for making a monolayer packaging articles. EP 2 886 602 A1 discloses a composition for preparing articles, preforms or containers comprising a base polyester, a copolyester-ether, a transition metal-based oxidation catalyst and a titanium compound. GB 2 435 394 A describes an oxygen scavenging composition comprises a hydrogen donor (e.g. polyvinylpyrrolidone or a dioxane), ascorbic acid or an oxygen-scavenging derivative thereof, a radical-generating photoinitiator, and optionally Vitamin E or a derivative thereof or a transition metal compound or complex, the composition including a polymer or oligomer. Mahan et al. discuss active barrier poly(ethylene terephthalate) materials and their PET copolymers, synthesized by melt polymerization of terephthalic acid with ethylene glycol and as active oxygen scavengers monoolein or 3-cyclohexene-1,1-dimethanol (Mahan et al., J. Appl. Polym. Sci. 2013, 4273-4283). US 8,029,842 B2 relates to an oxygen-scavenging composition comprising iron, silica gel, water, sodium chloride, a humectant salt selected from the group consisting of calcium chloride, lithium chloride, iodides, carbonates, sulfate salts, and combinations thereof. US 10,207,853 B2 discloses a polyester host polymer made by reacting at least one acid selected from the group consisting of terephthalic acid and isophthalic acid or their dimethyl esters with at least one glycol selected from the group consisting of ethylene glycol, diethylene glycol, 1,4 butane diol and 1,3 butane diol, and 1,4-cyclohexanedimethanol (CHDM); and an oxygen scavenging composition comprising one or more compounds having specific formulas based on isoprene units. US 2007/0138436 A1 describes an oxygen scavenging composition comprising a copolymer comprising polypropylene oxide segments and polymer segments and an oxidation catalyst. Wang et al. describe oxygen scavenging and oxygen barrier poly(1,2-butadiene) films containing an iron-complex catalyst (Wang et al., Macromol. Chem. Phys. 2019, 220, 1900294).

In view of the steadily increasing demand for polymer articles to be used in packaging of oxygen-sensitive goods, there is still a need for further polymeric materials having sufficient gas barrier properties as well as oxygen scavenging properties, for example, for packaging oxygen-sensitive food and beverage products.

Thus, the objective technical problem underlying the present invention was the provision of a polymer article, which has oxygen scavenging properties.

The object was solved by a polymer composition comprising
i) a polyester;
ii) an oxidizable organic polymer consisting of a branched or unbranched alkyl chain, which comprises at least one oxidizable C═C double bond.

Surprisingly, it was found that using an oxidizable organic polymer (ii) in a composition with a polyester (i), already without catalyst, significantly improves the oxygen consumption of the polymer composition compared to the pure polyester.

According to a preferred embodiment of the polymer composition, the polyester according to (i) is based on at least one polyhydric alcohol and at least one organic dicarboxylic acid. The at least one organic dicarboxylic acid is preferably one or more organic dicarboxylic acid having from 2 to 12 carbon atoms, preferably one or more aromatic dicarboxylic acid having from 8 to 12 carbon atoms. Preferably, the at least one organic dicarboxylic acid is selected from the group consisting of succinic acid, glutaric acid, adipic acid, surberic acid, azelaic acid, sebacic acid, decanedicarboxylic acid, maleic acid, fumaric acid, and phthalic acid, isophthalic acid, terephthalic acid, the isomeric naphthalenedicarboxylic acids and mixtures of two or more of these organic dicarboxylic acids, more preferred the at least one organic dicarboxylic acid comprises terephthalic acid. Instead of the free dicarboxylic acids it is also possible to use the corresponding dicarboxylic acid derivatives, for example dicarboxylic esters of alcohols having from 1 to 4 carbon atoms, or dicarboxylic anhydrides. The at least one polyhydric alcohol is preferably at least one diol having from 2 to 12 carbon atoms, preferably from 2 to 6 carbon atoms. Preferably, the at least one polyhydric alcohol comprises at least 1,4-butanediol. According to a preferred embodiment of the polymer composition, the polyester according to (i) is based on 1,4-butanediol, more preferred the polyester according to (i) is a copolymer based on 1,4-butanediol and at least one organic dicarboxylic acid as described above, more preferred a polyester based on 1,4-butanediol and terephthalic acid. A polyester based on 1,4-butanediol and terephthalic acid (polybutylene terephthalate, PBT) has preferably a viscosity number (VN) in the range of from 88 to 160 cm³/g, determined according to DIN EN ISO 1628-5 (October 2012).

According to a preferred embodiment of the polymer composition, the oxidizable organic polymer according to (ii) is selected from the group consisting of poly(1,4-isoprene), poly(1,4-butadiene) and mixtures of two or more thereof; and preferably comprises at least poly(1,4-butadiene). The poly(1,4-butadiene) has preferably an average molecular weight Mw in the range of from 100 to 10⁶ g/mol.

According to a preferred embodiment of the polymer composition, the polymer composition contains the oxidizable organic polymer according to (ii) in a weight based ratio to the polyester according to (i) (ratio (ii):(i)) in the range of from 0.1:100 to 10:100, preferably in the range of from 0.2:100 to 8:100, more preferred in the range of from 0.5:100 to 5:100.

According to a preferred embodiment of the polymer composition, the polymer composition further comprises:
iii) at least one iron containing catalyst,
   wherein the at least one iron containing catalyst according to (iii) is preferably selected from the group of ion containing salts; more preferred from the group consisting of Fe³⁺ containing salts, Fe²⁺ containing salts and mixtures of Fe³⁺ containing salts and Fe²⁺ containing salts; more preferred from the group of Fe³⁺ containing salts; more preferred from the group of Fe(III)stearate, Fe(III)pyrophosphate, Fe(III)citrate, Fe(III)acetylacetonate and mixtures of two or more of these Fe(III)salts; more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate. More preferred in the range of from 95 to 100 weight-% of the at least one iron containing catalyst consist of Fe(III)pyrophosphate, more preferred the at least one iron containing catalyst is Fe(III)pyrophosphate.

A polymer composition comprising (i), (ii) and additionally an iron containing catalyst (iii), especially Fe(III)acetylacetonate and/or Fe(III)pyrophosphate preferably at least Fe(III)pyrophosphate, as catalyst improved the oxygen consumption compared to a composition of polyester (i) and only catalyst as well as compared to the pure polyester (i).

Preferably, the polymer composition contains the at least one iron containing catalyst according to (iii) in a weight based ratio to the polyester according to (i) (ratio (iii):(i)) in the range of from 0.0001:100 to 5:100, preferably in the range of from 0.01:100 to 1:100, more preferred in the range of from 0.002:100 to 0.5:100.

Preferably, (i), (ii) and optionally (iii) are present in the polymer composition in form of a blend (compound).

According to a preferred embodiment of the polymer composition, the polymer composition contains a further compound capable of oxygen scavenging in an amount of less than 1 weight-%, preferably in the range of from 0 to 1 weight-%, more preferred in the range of from 0 to 0.5 weight-%, more preferred in the range of from 0 to 0.01 weight-%, based on the overall weight of the polymer composition. More preferred, the polymer composition does not contain a further compound capable of oxygen scavenging. A “further compound capable of oxygen scavenging” means oxygen scavengers derived from isoprenoids as described in US 10,2007,853 B2, especially oxygen scavenging molecules having formula (I), (II) and/or (III) as disclosed in US 10,2007,853 B2, especially column 2, line 23 to column 5, line 5 of US 10,2007,853 B2, the respective disclosure is incorporated herein by reference.

According to a preferred embodiment, the polymer composition comprises:
(i) a polyester, which comprises at least PBT;
(ii) an oxidizable organic polymer, which comprises at least poly(1,4-butadiene); and
(iii) optionally at least one iron containing catalyst, which comprises one or more Fe³⁺ containing salts selected from the group consisting of Fe(III)stearate, Fe(III)pyrophosphate, Fe(III)citrate, Fe(lll)acetylacetonate and mixtures of two or more of these Fe(lll)salts, more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate, more preferably is Fe(lll)pyrophosphate;
(iv) optionally one or more additive(s).

According to a preferred embodiment, the polymer composition comprises:
(i) a polyester, which comprises at least PBT;
(ii) an oxidizable organic polymer, which comprises at least poly(1,4-butadiene); and
(iii) at least one iron containing catalyst, which comprises one or more Fe³⁺ containing salts selected from the group consisting of Fe(III)stearate, Fe(III)pyrophosphate, Fe(III)citrate, Fe(lll)acetylacetonate and mixtures of two or more of these Fe(lll)salts, more preferred from the group consisting of Fe(III)pyrophosphate, Fe(lll)acetylacetonate, and mixtures of Fe(III)pyrophosphate and Fe(III)acetylacetonate, wherein the at least one iron containing catalyst according to (iii) preferably comprises at least Fe(III)pyrophosphate, more preferably is Fe(lll)pyrophosphate;
(iv) optionally one or more additive(s).

According to a further preferred embodiment, 95 to 100 weight-%, more preferred 98 to 100 weight-%, more preferred 99 to 100 weight-%, more preferred 100 weight-% of the polymer composition consist of:
(i) a polyester, which comprises at least PBT;
(ii) an oxidizable organic polymer, which comprises at least poly(1,4-butadiene); and
(iii) optionally at least one iron containing catalyst, which comprises one or more Fe³⁺ containing salts selected from the group consisting of Fe(III)stearate, Fe(III)pyrophosphate, Fe(III)citrate, Fe(lll)acetylacetonate and mixtures of two or more of these Fe(lll)salts, more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate, more preferably is Fe(lll)pyrophosphate;
(iv) optionally one or more additive(s).

According to a further preferred embodiment, 95 to 100 weight-%, more preferred 98 to 100 weight-%, more preferred 99 to 100 weight-%, more preferred 100 weight-% of the polymer composition consist of:
(i) a polyester, which comprises at least PBT;
(ii) an oxidizable organic polymer, which comprises at least poly(1,4-butadiene); and
(iii) at least one iron containing catalyst, which comprises one or more Fe³⁺ containing salts selected from the group consisting of Fe(III)stearate, Fe(III)pyrophosphate, Fe(III)citrate, Fe(lll)acetylacetonate and mixtures of two or more of these Fe(lll)salts, more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate, more preferably is Fe(III)pyrophosphate;
(iv) optionally one or more additive(s).

Preferably, the one or more additive(s) according to (iv) are selected from the group consisting of filler, impact modifier, surface-active substance, flame retardant, nucleating agent, oxidation stabilizer, lubricant, mold release aid, dye, reinforcing agent, biocide, anti-fog agent, plasticizer, colorant, pigment, stabilizer for protection against hydrolysis, stabilizer for protection against light, stabilizer for protection against heat and stabilizer against discoloration.

A filler is preferably selected from the group consisting of inorganic filler, organic filler, and mixtures of inorganic and organic filler. Inorganic fillers are preferably selected from the group consisting of silicate mineral, for example layered silicates such as antigorite, serpentine, horn-blende, amphibole, chrisotile, talc; zeolite; metal oxide such as kaolin, aluminum oxides, titanium oxides and iron oxides; metal salts such as chalk, carbonates and inorganic pigments such as titanium dioxide or zinc sulfide; and glass, preferably glass fiber. Organic fillers are preferably selected from the group consisting of carbon, melamine, rosin, cyclopentadienyl resins, graft polymers, and organic fibers, in particular carbon fiber, cellulose fiber, polyethylene fiber, polypropylene fiber, polyamide fiber, polyacrylonitrile fiber, polyester fiber based on aromatic and /or aliphatic dicarboxylic acid esters, polyurethane fiber, and mixtures of two or more of these fibers. Preferably, a filler is a reinforcing filler, which is to be understood as meaning the conventional organic and / or inorganic reinforcing fillers described above, preferably a reinforcing filler comprises one or more fibers selected from the group of glass fiber, carbon fiber, cellulose fiber, polyethylene fiber, polypropylene fiber, polyamide fiber, polyacrylonitrile fiber, polyester fiber based on aromatic and / or aliphatic dicarboxylic acid esters, polyurethane fiber, and mixtures of two or more of these fibers. Preferably, the reinforcing filer comprises glass fiber. The one or more fibers can be introduced as short cut, cut fibers, long fibers, tangled fibers or mixtures of two or more of these fiber forms. Additives such as impact modifier, surface-active substance, flame retardant, nucleating agent, oxidation stabilizer, lubricant, mold release aid, dye, reinforcing agent, biocide, anti-fog agent, plasticizer, colorant, pigment, stabilizer for protection against hydrolysis, stabilizer for protection against light, stabilizer for protection against heat and stabilizer against discoloration are known to the skilled person.

The one or more additive(s) is/are present in a weight based ratio to the polyester according to (i) (ratio (iv):(i)) in the range of from 0.1: 100 to 80:100, preferably in the range of from 0.1:100 to 75:100.

The polymer composition of the first aspect has oxygen scavenging properties, especially the polymer composition is able to consume oxygen in its surrounding. According to a further preferred embodiment, the polymer composition has an oxygen consumption of at least 5 mbar per gram polymer composition, more preferred in the range of from 5 to 25 mbar per gram polymer composition, more preferred in the range of from 6 to 15 mbar per gram polymer composition, more preferred in the range of from 10 to 15 mbar per gram polymer composition, determined according to Reference Example 2.

### 2^{nd} Aspect - Use of the Polymer Composition

In a second aspect, the invention relates to the use of the polymer composition according to the first aspect for the preparation of a polymer article. According to the second aspect, the invention also relates to a method for preparation of a polymer article using the polymer composition according to the first aspect. The polymer article (for both, use and method for preparation of a polymer article) is preferably selected from the group consisting of packaging article, sealing article, wrapping article, preferably for the packing, sealing, wrapping of oxygen-sensitive substances; more preferred for the preparation of a food packaging, food sealing or food wrapping article. Embodiments and preferred embodiments of the polymer composition are already disclosed above with respect to the first aspect; reference to said first aspect is made for details.

### 3^{rd} Aspect - Polymer Composition

A third aspect of the invention relates to a polymer article comprising the polymer composition according to the first aspect. Embodiments and preferred embodiments of the polymer composition are already disclosed above with respect to the first aspect; reference to said first aspect is made for details.

### 4^{th} Aspect - Method for Preparing a Polymer Composition

In a fourth aspect, the invention relates to method for preparing a polymer composition having oxygen consumption activity, comprising:
a) providing a polyester (i), an oxidizable organic polymer consisting of a branched or unbranched alkyl chain, which comprises at least one oxidizable C═C double bond (ii), optionally an iron containing catalyst (iii), and optionally one or more additive(s) (iv);
b) mixing (i), (ii), optionally (iii) and optionally (iv) provided according to (a) in order to obtain a mixture of (i), (ii), optionally (iii), and optionally (iv);
c) optionally drying the mixture obtained in (b), optionally at a temperature in the range of from 50 to 100° C. in order to remove water, thereby obtaining a dried mixture;
d) compounding, preferably at a temperature in the range of from 225 to 300° C., of the mixture obtained in (b) and/or the dried mixture obtained in (c), thereby obtaining a polymer composition in compounded form comprising (i), (ii), optionally (iii), and optionally (iv).

The polymer composition obtained in (d) is preferably a polymer composition according to the first aspect of the present invention. Embodiments and preferred embodiments of the polymer composition are already disclosed above with respect to the first aspect; reference to said first aspect is made for details.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”. Further, it is explicitly noted that the following set of embodiments is not the set of claims determining the extent of protection, but represents a suitably structured part of the description directed to general and preferred aspects of the present invention.

According to an embodiment (1), the present invention relates to a polymer composition comprising
i) a polyester;
ii) an oxidizable organic polymer consisting of a branched or unbranched alkyl chain, which comprises at least one oxidizable C═C double bond.

A preferred embodiment (2) concretizing embodiment (1) relates to said polymer composition, wherein the polyester according to (i) is based on 1,4-butanediol, preferably the polyester according to (i) is a copolymer based on 1,4-butanediol and at least one organic dicarboxylic acid, more preferred a polyester based on 1,4-butanediol and terephthalic acid.

A further preferred embodiment (3) concretizing embodiment (1) or (2) relates to said polymer composition, wherein the oxidizable organic polymer according to (ii) is selected from the group consisting of poly(1,4-isoprene), poly(1,4-butadiene) and mixtures of two or more thereof; and preferably comprises at least poly(1,4-butadiene).

A further preferred embodiment (4) concretizing any one of embodiments (1) to (3) relates to said polymer composition, which further comprises:

iii) at least one iron containing catalyst, wherein the at least one iron containing catalyst according to (iii) is preferably selected from the group of ion containing salts; more preferred from the group consisting of Fe³⁺ containing salts, Fe²⁺ containing salts and mixtures of Fe³⁺ containing salts and Fe²⁺ containing salts; more preferred from the group of Fe³⁺ containing salts; more preferred from the group of Fe(III)stearate, Fe(III)pyrophosphate, Fe(III)citrate, Fe(III)acetylacetonate and mixtures of two or more of these Fe(III)salts; more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate, more preferred in the range of from 95 to 100 weight-% of the at least one iron containing catalyst consist of Fe(III)pyrophosphate, more preferred the at least one iron containing catalyst is Fe(III)pyrophosphate.

A further preferred embodiment (5) concretizing any one of embodiments (1) to (4) relates to said polymer composition, wherein (i), (ii) and optionally (iii) are present in the polymer composition in form of a blend (compound).

A further preferred embodiment (6) concretizing any one of embodiments (1) to (5) relates to said polymer composition, which does not contain a further compound capable of oxygen scavenging.

A further preferred embodiment (7) concretizing any one of embodiments (1) to (6) relates to said polymer composition, which contains the oxidizable organic polymer according to (ii) in a weight based ratio to the polyester according to (i) in the range of from 0.1:100 to 10:100, preferably in the range of from 0.2:100 to 8:100, more preferred in the range of from 0.5:100 to 5:100.

A further preferred embodiment (8) concretizing any one of embodiments (1) to (7) relates to said polymer composition, which contains the at least one iron containing catalyst according to (iii) in a weight based ratio to the polyester according to (i) in the range of from 0.0001:100 to 5:100, preferably in the range of from 0.01:100 to 1:100, more preferred in the range of from 0.002:100 to 0.5:100.

A further preferred embodiment (9) concretizing any one of embodiments (1) to (8) relates to said polymer composition, which comprises, preferably consists of:
(i) a polyester, which comprises at least PBT;
(ii) an oxidizable organic polymer, which comprises at least poly(1,4-butadiene); and
(iii) optionally at least one iron containing catalyst, which comprises one or more Fe³⁺ containing salts selected from the group consisting of Fe(III)stearate, Fe(III)pyrophosphate, Fe(III)citrate, Fe(III)acetylacetonate and mixtures of two or more of these Fe(III)salts, more preferred from the group consisting of Fe(III)pyrophosphate, Fe(III)acetylacetonate, and mixtures of Fe(III)pyrophosphate and Fe(III)acetylacetonate, wherein the at least one iron containing catalyst according to (iii) preferably comprises at least Fe(III)pyrophosphate, more preferably is Fe(III)pyrophosphate;
(iv) optionally one or more additive(s).

A further preferred embodiment (10) concretizing any one of embodiments (1) to (9) relates to said polymer composition, having an oxygen consumption of at least 5 mbar per gram polymer composition, preferably in the range of from 5 to 25 mbar per gram polymer composition, more preferred in the range of from 6 to 15 mbar per gram polymer composition, more preferred in the range of from 10 to 15 mbar per gram polymer composition, determined according to Reference Example 2.

An embodiment (11) of the present invention relates to the use of the polymer composition according to any one of embodiments (1) to (10) for the preparation of a polymer article, preferably selected from the group consisting of packaging article, sealing article, wrapping article, preferably for the packing, sealing, wrapping of oxygen-sensitive substances; more preferred for the preparation of a food packaging, food sealing or food wrapping article.

An embodiment (12) of the present invention relates to a polymer article comprising the polymer composition according to any one of embodiments (1) to (10).

An embodiment (13) of the present invention relates to method for preparing a polymer composition having oxygen consumption activity, comprising:
e) providing a polyester (i), an oxidizable organic polymer consisting of a branched or unbranched alkyl chain, which comprises at least one oxidizable C═C double bond (ii), optionally an iron containing catalyst (iii), and optionally one or more additive(s) (iv);
f) mixing (i), (ii), optionally (iii) and optionally (iv) provided according to (a) in order to obtain a mixture of (i), (ii), optionally (iii), and optionally (iv);
g) optionally drying the mixture obtained in (b), optionally at a temperature in the range of from 50 to 100° C. in order to remove water, thereby obtaining a dried mixture;
h) compounding, preferably at a temperature in the range of from 225 to 300° C., of the mixture obtained in (b) and/or the dried mixture obtained in (c), thereby obtaining a polymer composition in compounded form comprising (i), (ii), optionally (iii), and optionally (iv).

It is explicitly noted that the preceding set of embodiments is not the set of claims determining the extent of protection, but represents a suitably structured part of the description directed to general and preferred aspects of the present invention.

The present invention is further illustrated by the following reference examples, comparative examples, and examples.

### EXAMPLES

Chemicals

| | | |
|---|---|---|
| Name | Details | Supplier |
| Fe(III)pyrophosphate | Fe₄(P₂O₇)₃ | Sigma Aldrich |
| Fe(III)stearate | C₅₄H₁₀₅FeO₆ | Sigma Aldrich |
| Fe(III)citrate | C₆H₅FeO₇ | Sigma Aldrich |
| Fe(III)acac (Fe(III)acetylacetonate) | C₁₅H₂₁FeO₆ | Sigma Aldrich |
| polybutylene terephthalate (PBT) | VN = 160 cm³/dl | BASF SE |
| Poly(1,4-butadiene) | Mn = 5000 g/mol | Sigma Aldrich |

### Reference Example 1: Determination of Viscosity Number

Viscosity number (VN) was determined according to DIN EN ISO 1628-5 (October 2012).

### Reference Example 2: Oxygen Consumption Testing

A predetermined amount (5 g) of a compound granulate as indicated in Table 1 was loaded in a 20 mL vial, which was closed by crimping a lid onto the vial. After crimping, the air composition inside the vial resembled that of the surrounding air and the pressure inside the vial was determined by using a manometer. The pressure decrease was determined by measuring the pressure inside the crimped vial as function of time. In Table 1 an overview of the maximum decrease of the pressure inside the closed vessel is presented, expressed as maximum pressure decrease in mbar per gram of compound.

### Example 1: Preparation of Compound Granulate E1

A compound granulate was prepared as follows: PBT (19.58 g) was combined with poly(1,4-butadiene) (0.4 g) and Fe(III) stearate (0.024 g) in a glass container and dried overnight at 80° C. under vacuum to reduce the water content in the PBT. After drying of the physical mixture, the mixture was added to a DSM-IV mini-extruder, which was pre-heated to 260° C. The mixture was molten in the mini-extruder and was compounded for 3 minutes at a temperature of 260° C. After this time, the molten compound from PBT was expelled from the extruder as a strand. This strand was then granulated by hand to form the final product (compound granulate of inventive example 1 - E1). Table 1 shows the educts and amounts used as well as the result of the oxygen consumption testing done in accordance with Reference Example 2.

### Examples 2 to 7

The inventive compound granulates of examples 2 to 7 (E2 - E7) were prepared using the same method as described above in example 1 for E1, an overview of the educts and amounts used as well as the results of the oxygen consumption testing done in accordance with Reference Example 2 are shown in Table 1.

### Comparative Examples 1 to 2

The compound granulates of comparative examples 1 to 2 (C1-C2) examples were prepared using the same method as described above in example 1 for E1, an overview of the compounds and amounts used as well as the results of the oxygen consumption testing done in accordance with Reference Example 2 are shown in Table 1.

TABLE 1

Composition of compounds of inventive and comparative examples and results of oxygen consumption testing

| Example | Compound composition | | | | | Max. pressure decrease (mbar) per gram* |
|---|---|---|---|---|---|---|
| | PBT (weight-%) | oxidizable organic polymer | oxidizable organic polymer content (weight-%) | Catalyst | Catalyst content (weight-%) | |
| E1 | 97.88 | Poly(1,4-butadiene) | 2 | Fe(III)stearate | 0.12 | 6.8 |
| E2 | 97.88 | Poly(1,4-butadiene) | 2 | Fe(III)pyrophosphate | 0.12 | 12.4 |
| E3 | 97.88 | Poly(1,4-butadiene) | 2 | Fe(III)citrate | 0.12 | 6.4 |
| E4 | 97.88 | Poly(1,4-butadiene) | 2 | Fe(III)acac | 0.12 | 13.2 |
| E5 | 98.95 | Poly(1,4-butadiene) | 1 | Fe(III)acac | 0.05 | 13.6 |
| E6 | 99.38 | Poly(1,4-butadiene) | 0.5 | Fe(III)acac | 0.12 | 10.4 |
| E7 | 98.00 | Poly(1,4-butadiene) | 2 | none | 0 | 13.6 |
| C1 | 99.88 | - | 0 | Fe(III)stearate | 0.12 | 0 |
| C2 | 97.88 | Poly(1,2-butadiene) | 2 | Fe(III)stearate | 0.12 | 1.4 |
| C3 | 100 | None | 0 | None | 0 | 0 |

* measurement error ± 0.6 mbar per gram

It could be seen that using poly(1,4-butadiene) as oxidizable organic polymer in a compound with PBT significantly improved the oxygen consumption, i.e. the pressure decrease in mbar per gram of the respective compound (E7) was strongly improved compared to a compound of PBT and only catalyst (C1) and also compared to pure PBT (C3). Using an iron containing catalyst, especially Fe(III)acetylacetonate (E4, E5) or Fe(III)pyrophosphate (E2), as catalyst also improved the oxygen consumption compared to a blend of PBT and only catalyst (C1) as well as compared to pure PBT (C3). Using poly(1,2-butadiene) instead of poly(1,4-butadiene) showed a remarkably worse oxygen consumption even if an iron containing catalyst (Fe(III)stearate, C2) was used as catalyst.

### Cited Literature

EP 1 889 704 A1
EP 2 886 602 A1
GB 2 435 394 A
Mahan et al., J. Appl. Polym. Sci. 2013, 4273-4283
US 8,029,842 B2
US 10,207,853 B2
US 2007/0138436 A1
Wang et al., Macromol. Chem. Phys. 2019, 220, 1900294

1. A polymer composition comprising
i) a polyester, which is a copolymer based on 1,4-butanediol and at least one organic dicarboxylic acid;
ii) an oxidizable organic polymer consisting of a branched or unbranched alkyl chain, which comprises at least one oxidizable C═C double bond, which is poly(1,4-butadiene).

2. The polymer composition of claim 1, wherein the polyester according to (i) is polyester based on 1,4-butanediol and terephthalic acid.

3. The polymer composition of claim 1, which further comprises:
iii) at least one iron containing catalyst.

4. The polymer composition of claim 1, wherein (i), (ii) and optionally (iii) are present in the polymer composition in form of a blend.

5. The polymer composition of claim 1, which does not contain a further compound capable of oxygen scavenging.

6. The polymer composition of claim 1, containing the oxidizable organic polymer according to (ii) in a weight based ratio to the polyester according to (i) in the range of from 0.1:100 to 10:100.

7. The polymer composition of claim 3, containing the at least one iron containing catalyst according to (iii) in a weight based ratio to the polyester according to (i) in the range of from 0.0001:100 to 5:100.

8. The polymer composition of claim 1 comprising:
(i) a polyester, which comprises at least PBT;
(ii) an oxidizable organic polymer, which is poly(1,4-butadiene);
(iii) optionally at least one iron containing catalyst, which comprises one or more Fe³⁺ containing salts selected from the group consisting of Fe(III)stearate, Fe(III)pyrophosphate, Fe(III)citrate, Fe(III)acetylacetonate and mixtures of two or more of these Fe(III)salts;
(iv) optionally one or more additive(s).

9. The polymer composition of claim 1 having an oxygen consumption of at least 5 mbar per gram polymer composition, determined according to Reference Example 2.

10. (canceled)

11. A polymer article comprising the polymer composition according to claim 1.

12. A method for preparing a polymer composition having oxygen consumption activity, comprising:
a) providing a polyester (i), which is a copolymer based on 1,4-butanediol and at least one organic dicarboxylic acid, an oxidizable organic polymer consisting of a branched or unbranched alkyl chain, which comprises at least one oxidizable C═C double bond, which is poly(1,4-butadiene) (ii), optionally an iron containing catalyst (iii), and optionally one or more additive(s) (iv);
b) mixing (i), (ii), optionally (iii) and optionally (iv) provided according to (a) to obtain a mixture of (i), (ii), optionally (iii), and optionally (iv);
c) optionally drying the mixture obtained in (b), optionally at a temperature in a range of from 50 to 100° C. to remove water, thereby obtaining a dried mixture;
d) compounding the mixture obtained in (b) and/or the dried mixture obtained in (c), thereby obtaining a polymer composition in compounded form comprising (i), (ii), optionally (iii), and optionally (iv).

13. (canceled)

14. The polymer composition of claim 3 wherein the iron containing catalyst is an Fe³⁺ containing salt, an Fe²⁺ containing salt, or a mixture of Fe³⁺ and Fe²⁺ containing salts.

15. The polymer composition of claim 3 wherein the iron containing catalyst is selected from the group consisting of Fe(III)stearate, Fe(III)pyrophosphate, Fe(III)citrate, Fe(III)acetylacetonate, and mixtures of two or more of these Fe(III)salts.

16. The polymer composition of claim 15 wherein the iron containing catalyst comprises Fe(III) pyrophosphate in a range of 95 to 100 weight % of the iron containing catalyst.

17. The polymer article according to claim 11 selected from the group consisting of a packaging article, a sealing article, and a wrapping article.
